(19) United States
(12) Patent Application Publication
(10) Pub. No.: US 2023/0212028 A1
(43) Pub. Date: Jul. 6, 2023

(54) PROCESS FOR MAKING A PARTICULATE (OXY) HYDROXIDE

(71) Applicant: BASF SE, Ludwigshagen am Rhein (DE)

(72) Inventors: Benjamin Johannes Herbert BERGNER, Ludwigshafen (DE); Thorsten BEIERLING, Ludwigshafen (DE)

(21) Appl. No.: 17/999,057

(22) PCT Filed: May 28, 2021
(86) PCT No.: PCT/EP2021/064322

§ 371 Date: Nov. 17, 2022

(30) Foreign Application Priority Data
Jun. 4, 2020 (EP) 20178317.2

(51) Int. Cl. C01G 53/00

(52) U.S. Cl. CPC C01G 53/40; C01P 2002/52; C01P 2004/61; C01P 2004/84; C01P 2006/40; C01P 2004/03

(57) ABSTRACT

Process for making a particulate (oxy)hydroxide of TM wherein TM comprises nickel and where-in said process comprises the steps of: (a) Providing an aqueous solution (α) containing water-soluble salts of Ni and of at least one transition metal selected from Co and Mn, and, optionally, at least one further metal sel-ected from Ti, Zr, Mo, W, Al, Mg, Nb, and Ta, and an aqueous solution (β) containing an alkali metal hydroxide and, optionally, an aqueous solution (γ) containing ammonia, (b) combining a solution (α) and a solution (β) and, if applicable, a solution (γ) at a pH value in the range of from 12.0 to 13.0 in a stirred tank reactor, thereby creating solid particles of a hydroxide containing nickel, said solid particles being slurried, (c) transferring said slurry into another stirred tank reactor and combining it with a solution (α) and a solution (β) and, if applicable, a solution (γ) at a pH value in the range of from 11.0 to 12.7 and at conditions wherein the solubility of nickel is higher than in step (b), wherein the stirring speed is reduced in the course of step (c).

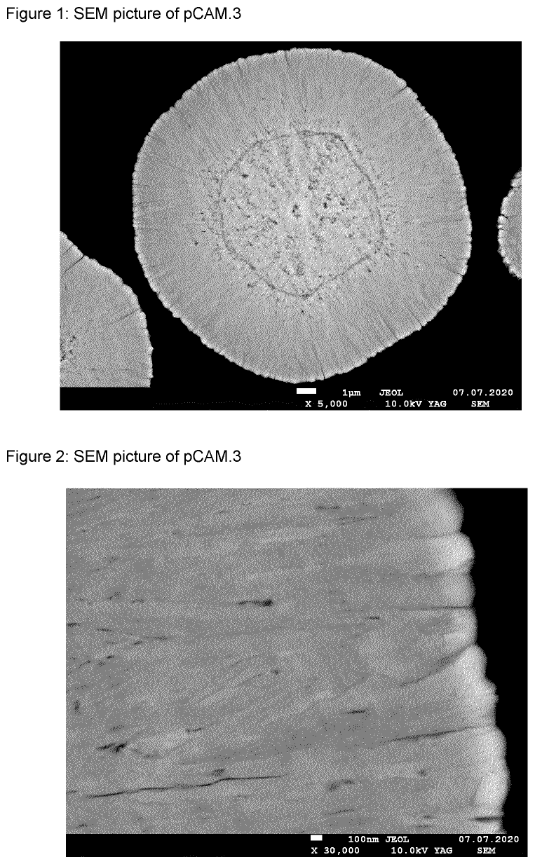

The present invention is directed towards a process for making a particulate (oxy)hydroxide of TM wherein TM comprises nickel and wherein said process comprises the steps of:
(a) Providing an aqueous solution (a) containing water-soluble salts of Ni and of at least one transition metal selected from Co and Mn, and, optionally, at least one further metal selected from Ti, Zr, Mo, W, Al, Mg, Nb, and Ta, and an aqueous solution (β) containing an alkali metal hydroxide and, optionally, an aqueous solution (γ) containing ammonia,
(b) combining a solution (α) and a solution (β) and, if applicable, a solution (γ) at a pH value in the range of from 12.0 to 13.0 in a stirred tank reactor, thereby creating solid particles of a hydroxide containing nickel, said solid particles being slurried,
(c) transferring at least a fraction of the slurry obtained in step (b) into another stirred tank reactor and combining it with a solution (α) and a solution (β) and, if applicable, a solution (γ) at a pH value in the range of from 11.0 to 12.7 and at conditions wherein the solubility of nickel is higher than in step (b),

wherein the stirring speed is reduced in the course of step (c).

Lithiated transition metal oxides are currently being used as electrode active materials for lithium-ion batteries. Extensive research and developmental work have been performed in the past years to improve properties like charge density, specific energy, but also other properties like the reduced cycle life and capacity loss that may adversely affect the lifetime or applicability of a lithium-ion battery. Additional effort has been made to improve manufacturing methods.

In a typical process for making cathode materials for lithium-ion batteries, first a so-called precursor is being formed by co-precipitating the transition metals as carbonates, oxides or preferably as hydroxides that may or may not be basic, for example oxyhydroxides. The precursor is then mixed with a source of lithium such as, but not limited to LiOH, Li₂O or Li₂CO₃ and calcined (fired) at high temperatures. Lithium salt(s) can be employed as hydrate(s) or in dehydrated form. The calcination—or firing—often also referred to as thermal treatment or heat treatment of the precursor—is usually carried out at temperatures in the range of from 600 to 1,000° C. During the thermal treatment a solid-state reaction takes place, and the electrode active mated-al is formed. The thermal treatment is performed in the heating zone of an oven or kiln.

A typical class of cathode active materials delivering high energy density contains a high amount of Ni (Ni-rich), for example at least 80 mol-%, referring to the content of non-lithium metals. However, the energy density still needs improvement.

To a major extent, properties of the precursor translate into properties of the respective electrode active material to a certain extent, such as particle size distribution, content of the respective transition metals and more. It is therefore possible to influence the properties of electrode active materials by steering the properties of the precursor.

It was therefore an objective of the present invention to provide precursors for electrode active materials with high energy density and a simple process for manufacturing them.

Accordingly, the process defined at the outset has been found, hereinafter also referred to as inventive process or process according to the present invention. The inventive process is a process for making a particulate (oxy)hydroxide of TM. Said particulate (oxy)hydroxide then serves as a precursor for electrode active materials, and it may therefore also be referred to as precursor.

In one embodiment of the present invention, the resultant precursor is comprised of secondary particles that are agglomerates of primary particles.

In one embodiment of the present invention the specific surface (BET) of the resultant precursor is in the range of from 2 to 10 m²/g, determined by nitrogen adsorption, for example in accordance with to DIN-ISO 9277:2003-05.

The precursor is an (oxy)hydroxide of TM wherein TM comprises Ni and at least one transition metal selected from Co and Mn, and, optionally, at least one further metal selected from Ti, Zr, Mo, W, Al, Mg, Nb, and Ta.

In one embodiment of the present invention, TM is a combination of metals according to general formula (I)

(NiₐCo_{b}Mn_{c})_{1-d}M_{d} (I)

with

a being in the range of from 0.6 to 0.95, preferably from 0.8 to 0.92,

b being in the range of from 0.025 to 0.2, preferably from 0.025 to 0.15,

c being in the range of from zero to 0.2, preferably from zero to 0.15,

and d being in the range of from zero to 0.1, preferably from zero to 0.05,

M is selected from Mg, Al, Ti, Zr, Mo, W, Al, Mg, Nb, and Ta,

a+b+c=1.

TM may contain traces of further metal ions, for example traces of ubiquitous metals such as sodium, calcium or zinc, as impurities but such traces will not be taken into account in the description of the present invention. Traces in this context will mean amounts of 0.05 mol-% or less, referring to the total metal content of TM.

The inventive process comprises the following steps (a) and (b) and (c), hereinafter also referred to as step (a) and step (b) and step (c), or briefly as (a) or (b) or (c), respectively. The inventive process will be described in more detail below.

Step (a) includes providing an aqueous solution (α) containing water-soluble salts of Ni and of at least one transition metal selected from Co and Mn, and, optionally, at least one further metal selected from Ti, Zr, Mo, W, Al, Mg, Nb, and Ta, and an aqueous solution (β) containing an al-kali metal hydroxide and, optionally, an aqueous solution (γ) containing ammonia.

The term water-soluble salts of cobalt and nickel or manganese or of metals other than nickel and cobalt and manganese refers to salts that exhibit a solubility in distilled water at 25° C. of 25 g/l or more, the amount of salt being determined under omission of crystal water and of water stemming from aquo complexes. Water-soluble salts of nickel and cobalt and manganese may preferably be the respective water-soluble salts of Ni²⁺ and Co²⁺ and Mn²⁺. Examples of water-soluble salts of nickel and cobalt are the sulfates, the nitrates, the acetates and the halides, especially chlorides. Preferred are nitrates and sulfates, of which the sulfates are more preferred.

Said aqueous solution (α) preferably contains Ni and further metal(s) in the relative concentration that is intended as TM of the precursor.

Solution(s) (α) may have a pH value in the range of from 2 to 5. In embodiments wherein higher pH values are desired, ammonia may be added to solution (α). However, it is preferred to not add ammonia to solution (α).

In one embodiment of the present invention, one solution (α) is provided.

In another embodiment of the present invention, at least two different solutions (α) are provided, for example solution (α1) and solution (α2), in with different relative amounts of water-soluble salts of metals are provided. In one embodiment of the present invention, solution (α1) and solution (α2) are provided wherein the relative amount of nickel is higher in solution (α1) than in solution (α2), for example at the expense of Mn or Co.

In step (α), in addition an aqueous solution of alkali metal hydroxide is provided, hereinafter also referred to as solution (β). An example of alkali metal hydroxides is lithium hydroxide, preferred is potassium hydroxide and a combination of sodium and potassium hydroxide, and even more preferred is sodium hydroxide.

Solution (β) may contain some amount of carbonate, e.g., 0.1 to 2% by weight, referring to the respective amount of alkali metal hydroxide, added deliberately or by aging of the solution or the respective alkali metal hydroxide.

Solution (β) may have a concentration of hydroxide in the range from 0.1 to 12 mol/l, preferably 6 to 10 mol/l.

The pH value of solution (β) is preferably 13 or higher, for example 14.5.

In the inventive process, it is preferred to use ammonia but to feed it separately as solution (γ) or in solution (β) but not in solution (α).

In one embodiment of the present invention, the following steps (b) and (c) are performed at temperatures in the range from 10 to 85° C., preferably at temperatures in the range from 20 to 60° C. Preferably, step (b) and (c) are performed at the same temperature.

In the context of the inventive process, the pH value refers to the pH value of the respective solution or slurry at 23° C.

In one embodiment of the present invention, steps (b) and (c) are performed at the same pressure, for example at ambient pressure.

It is preferred to perform steps (b) and (c) in a cascade of a least two stirred tank reactors, for example two or three stirred tank reactors.

Step (b) includes combining a solution (α) and a solution (β) and, if applicable, a solution (γ) at a pH value in the range of from 12.0 to 13.0 in a stirred tank reactor, thereby creating solid particles of a hydroxide containing nickel, said solid particles being slurried. Thus, a slurry is obtained.

In one embodiment of the present invention, step (b) has a duration in the range of from rt·0.03 to rt·1.0, preferably either from rt·0.03 to rt·0.2 or from rt·0.8 to rt·1.0 wherein rt is the average reaction time of steps (b) to (e) or the average residence time of the reactor system in which steps (b) and (c) are carried out.

In one embodiment of the present invention, in the course of step (b), stirring is performed with a speed providing a medium dissipation rate in the range of from 0.1 W/kg to 7 W/kg, preferably from 0.5 W/kg to 5 W/kg. For example, in case of a stirred tank reactor with a volume of 3.2 liter, typical stirring speeds range from 400 rpm to 1000 rpm (revolutions per minute).

In step (b), a slurry is obtained.

Step (c) includes transferring at least a fraction of the slurry obtained in step (b) into another stirred tank reactor and combining it with a solution (α) and a solution (β) and, if applicable, a solution (γ) at a pH value in the range of from 11.0 to 12.7 and at conditions wherein the solubility of nickel is higher than in step (b).

The transfer of at least a fraction of the slurry obtained in step (b) means that at least some of the solids of the slurry and at least some of the continuous phase, thus, the mother liquor, is transferred into another stirred tank reactor. The ratio of solids to continuous phase may or may not be the same as obtained in step (b).

In a special embodiment of step (c), the entire slurry produced during step (b) is transferred into another stirred tank reactor. In another embodiment, a fraction is transferred, for example from 10 to 50 vol-% of the slurry obtained in step (b) are transferred.

In this context, the term “solubility of nickel” refers to the solubility of Ni²⁺ salts. In the present invention, in step (c) the solubility of nickel may be in the range of from 0.01 ppm to 500 pm, preferably 1 to 300 ppm. Solubilities can be measured by separating the liquid from the solid phase by filtration followed by an ICP-OES analysis, inductively coupled plasma—optical emission spectrometry, to determine the concentration of nickel ions in the solution.

In the context of step (c), the solubility of nickel may be enhanced, e.g., by reducing the pH value or by increasing the concentration of complexing agents, for example of ammonia.

In one embodiment of the present invention, in step (c) the solubility of nickel is increased by the factor of 10 to 50 000, preferably from 100 to 8 000, compared to step (b).

In one embodiment of the present invention, the pH value in step (c) is lower by at least 0.2, for example by 0.3 to 0.7, than in step (b). For example, if the pH value during step (b) is exactly 12.0, then the pH value in step (c) is selected to be in the range of from 9.0 to 11.8. The change in pH value may be achieved, e.g., by decreasing the speed of addition of solution (β) or by increasing the speed of addition of solution (α), or by decreasing the amount of ammonia, or by a combination of at least two of the foregoing measures. It is possible as well to modify solution (β) by introducing a solution of alkali metal hydroxide with a lower concentration.

In another embodiment of the present invention, in step (c) the concentration of complexing agent, for example of ammonia, is higher than in step (b). A higher concentration of complexing agent may be accomplished by adding an additional complexing agent, or more ammonia. The addition or more ammonia may be effected by adding a solution (γ) in step (c) but not in step (b), or by adding a higher concentrated solution (γ) in step (c) than in step (b), or by adding more solution (γ) per time unit in step (c) than in step (b). It is preferred to add more solution (γ) per time unit in step (c) than in step (b).

In one embodiment of the present invention, the ammonia concentration in the slurry is higher than in step (b).

In the course of step (c) the stirring speed is reduced, for example, in the course of step (c) the stirring speed drops by a factor of 0.25 to 0.75, preferably from 0.25 to 0.5.

In one embodiment of the present invention, the stirring speed in step (c) is reduced continuously, for example linearly.

In one embodiment of the present invention, the stirring speed in step (c) is reduced step-wisely, for example in one step or in two to ten steps.

In one embodiment of the present invention, the stirring speed in the beginning of step (c) is the same as or lower than in step (b). In this context, “lower than in step (b)” refers to the stirring speed at the end of step (b).

In one embodiment of the present invention, solutions (α) used in steps (b) have a different composition compared to the solutions (α) used in step (c), for example, the nickel content of solutions (α) used in step (c) is lower compared to the nickel content of solutions (α) used in steps (b). In other embodiments, solution (α) used in step (b) has the same composition as solution (α) used in step (c).

In one embodiment of the present invention, steps (b) and (c) are performed under inert gas, for example a noble gas such as argon, or under N2.

In one embodiment of the present invention, in total a slight excess of hydroxide is applied, for example 0.1 to 10 mole-%, referring to TM.

In one embodiment of the present invention, during at least one of steps (b) and (c), mother liquor is withdrawn from the slurry, for example by way of a clarifier, preferably in step (c). In other embodiments, no mother liquor is removed during either of steps (b) and (c).

In one embodiment of the present invention, the addition speed of solutions (α) and (β) in liters per hour is increased in the course of step (c), for example by a factor of 1.5 to 20, preferably from 3 to 10.

In one embodiment of the present invention, the average diameter (D50) of the particles, measured by dynamic light scattering, grows linearly with the 3^{rd} root of the solids content (in g/L).

By performing the inventive process, precursors for electrode active materials with high energy density are obtained.

A further aspect of the present invention is related to particulate mixed metal (oxy)hydroxides, hereinafter also referred to as inventive precursors. Inventive precursors are useful for making electrode active materials with a high energy density, for example 600 to 950 W·h/kg, preferably from 800 to 950 W·h/kg by converting them with a source of lithium. Inventive precursors may be manufactured according to the inventive process.

Inventive precursors are particulate materials. In one embodiment of the present invention, inventive precursors have an average particle diameter D50 in the range of from 3 to 20 μm, preferably from 5 to 16 μm. The average particle diameter may be determined, e. g., by light scattering or LASER diffraction or electroacoustic spectroscopy. The particles are composed of agglomerates from primary particles, and the above particle diameter refers to the secondary particle diameter.

The secondary particles of inventive precursors may be considered core-shell particles, with the primary particles in the core mainly being randomly oriented and in the shell mainly radially oriented. The composition of metals in core and shell are preferably the same.

In one embodiment of the present invention, especially when manufactured according to a batch process, inventive precursors comprise Ni and at least one transition metal selected from Co and Mn, and, optionally, at least one further metal selected from Ti, Zr, Mo, W, Al, Mg, Nb, and Ta, wherein its primary particles in the shell mainly have a radial orientation and wherein the secondary particles have a product of span and form factor in the range of from 0.3 to 0.6 and a ratio of secondary particle diameter to core diameter below 7.5.

In another embodiment of the present invention, especially when manufactured according to a continuous process, inventive precursors comprise Ni and at least one transition metal selected from Co and Mn, and, optionally, at least one further metal selected from Ti, Zr, Mo, W, Al, Mg, Nb, and Ta, wherein its primary particles in the shell mainly have a radial orientation and wherein the particles have a product of span and form factor in the range of from 0.8 to 1.4 and a ratio of secondary particle diameter to core diameter in the range of from 1.2 to 1.6.

The form factor is calculated from the perimeter and area determined from top view SEM images: Form factor=(4π·area)/(perimeter)². The span is defined as [(D90)−(D10)] divided by (D50) and is a measure of the width of the particle diameter distribution.

Preferably, the core of the secondary particles corresponds to the particles generated in step (b) of the inventive process and the shell to the particles generated in step (c).

In one embodiment of the present invention, inventive precursors correspond to the general formula TM(O)ₓ(OH)_{y}, wherein x and y are average values, and x is from zero to 1.5 and y is in the range of from zero to 2, wherein the sum of x+y is at least 1 and at most 2.5.

In one embodiment of the present invention, TM is a combination of metals according to general formula (I)

(NiₐCo_{b}Mn_{c})_{1-d}M_{d} (I)

with

a being in the range of from 0.6 to 0.95, preferably from 0.8 to 0.92,

b being in the range of from 0.025 to 0.2, preferably from 0.025 to 0.15,

c being in the range of from zero to 0.2, preferably from zero to 0.15,

and d being in the range of from zero to 0.1, preferably from zero to 0.05,

M is selected from Mg, Al, Ti, Zr, Mo, W, Al, Mg, Nb, and Ta,

a+b+c=1.

TM may contain traces of further metal ions, for example traces of ubiquitous metals such as sodium, calcium or zinc, as impurities but such traces will not be taken into account in the de-scription of the present invention. Traces in this context will mean amounts of 0.05 mol-% or less, referring to the total metal content of TM.

The invention is further illustrated by working examples.

### General Remarks

Percentages of solution refer to % by weight unless expressly mentioned otherwise.

All pH values were measured outside the stirred tank reactor at 23° C.

rpm: Revolutions per minute

Average diameter (D50) and (d50) may be used interchangeably. The average diameter refers to the volume-based average particle diameter.

All experiments are performed in a continuously stirred tank reactor, volume 3.2 liter, with clarifier system attached to the top of the stirred tank reactor and with a stirrer with a two-stage cross-blade stirrer. During step (c), the particle size distribution was monitored by taking aliquots and characterizing them by dynamic light scattering (DLS).

I. Manufacture of Precursors

Step (α.1)

The following aqueous solutions were made:

(α.1): aqueous solution of NiSO₄, CoSO₄ and MnSO₄, molar ratio Ni:Co:Mn=87.0:5.0:8.0, overall transition metal concentration: 1.65 mol/kg

(β.1): aqueous 25 wt. % NaOH solution

(γ.1): 25% ammonia (NH₃) solution

Step (b.1):

A stirred tank reactor with a volume of 2.4 l was charged with 2 l deionized water at 55° C. The reactor had an overflow to a collection vessel at the top so that slurry was continuously collected. The reactor continuously fed with solution (α.1), (β.1) and (γ.1) in a way that the pH value of the mother liquor was 12.2 and the molar ratio of NH₃ to the sum of Ni, Co & Mn in the reactor was 0.15. The individual flow rates of the solutions, further referred to as fᵢ with i referring to the number of the corresponding solution, were adjusted to meet a residence time rt=V/(f_{α}+f_{β}+f_{γ})=5h. The particle size distribution in the reactor is monitored by taking samples and characterizing them by dynamic light scattering (DLS). After operating the reactor for a time of 15 hours, the particle size distribution did not change any more. Subsequently, the collection vessel was emptied and three seed slurry fractions si, s₂ and s₃ were collected for 5 hours each. All seed slurry fractions have a solid content of 120 g/l and they are characterized by the properties listed below. The solid content is defined by g solid per liter of suspension. The span is defined by (d90−d10)/d50.

TABLE 1
Characterization of particles from step (b.1)

| fraction | d50 | span |
|---|---|---|
| s₁ | 4.4 | 1.8 |
| s₂ | 4.6 | 1.6 |
| s₃ | 4.1 | 1.7 |

I.1 Procedure for Manufacturing the Comparative Precursor C-pCAM.1, Step C-(c.1)

A stirred reactor with a volume of 3.2 l was charged with 1.6 l deionized water containing 61 g ammonium sulfate and heated to 55° C. under nitrogen atmosphere. Subsequently, solution (β.1) was added in a way that the pH value was set to 11.8 and the stirrer was set to 500 rpm. Subsequently, 320 ml of slurry si were added. The reactor continuously fed with solution (α.1), (β.1) and (γ.1) in a way that the pH value of the mother liquor was 11.8 and the molar ratio of NH₃ to the sum of Ni, Co and Mn in the reactor was 0.55. Mother liquor was separated from the solid and removed from the reactor by a clarifier attached to the top of the reactor. The individual flow rates of the solutions, further referred to as fᵢ with i referring to the number of the corresponding solution, were adjusted to meet a residence time rt=V/(f_{α}+f_{β}+f_{γ})=5 h. The stirrer speed was kept constant during step C-(c.1). The particles were grown until they reached a particle size of around 13-14 μm and subsequently filtrated, washed with deionized water, dried and sieved using a mesh size of 30 μm to obtain C-pCAM.1

I.2 Procedure for Manufacturing the Comparative Precursor C-pCAM.2, Step C-(c.2)

A stirred reactor with a volume of 3.2 l was charged with 1.6 l deionized water containing 61 g ammonium sulfate and heated to 55° C. under nitrogen atmosphere. Subsequently, solution (β.1) was added in a way that the pH value was set to 12.05 and the stirrer was set to 1000 rpm. Subsequently, 320 ml of slurry s₂ were added. The reactor continuously fed with solution (α.1), (β.1) and (γ.1) in a way that the pH value of the mother liquor was 12.05 and the molar ratio of NH₃ to the sum of Ni, Co and Mn in the reactor was 0.55. Mother liquor was continuously separated from the solid and removed from the reactor by a clarifier attached to the top of the reactor. The individual flow rates of the solutions, further referred to as fᵢ with i referring to the number of the corresponding solution, were adjusted to meet a residence time rt=V/(f_{α}+f_{β}+f_{γ})=5 h. The stirrer speed was kept constant during step C-(c.2). The particles were grown until they reached a particle size of around 13-14 μm and subsequently collected by filtration i, washed with deionized water, dried under air and sieved using a mesh size of 30 μm to obtain C-pCAM.2.

I.3 Procedure for Manufacturing the Inventive Precursor pCAM.3, Step (c.3)

A stirred reactor with a volume of 3.2 l was charged with 1.6 l deionized water containing 61 g ammonium sulfate and heated to 55° C. under nitrogen atmosphere. Subsequently, solution (β.1) was added in a way that the pH value was set to 12.05 and the stirrer was set to 1000 rpm. Subsequently, 320 ml of slurry s₃ were added. The reactor continuously fed with solution (α.1), (β.1) and (γ.1) in a way that the pH value of the mother liquor was 12.05 and the molar ratio of NH₃ to the sum of Ni, Co and Mn in the reactor was 0.55. Mother liquor was continuously separated from the solid and removed from the reactor by a clarifier attached to the top of the reactor. The individual flow rates of the solutions, further referred to as fᵢ with i referring to the number of the corresponding solution, were adjusted to meet a residence time rt=V/(f_{α}+f_{β}+f_{γ})=5 h. The stirrer speed was firstly kept at 1000 rpm, then reduced to 650 rpm when the particles reached 12 μm and finally reduced to 500 rpm when the particles reached 12 μm. The particles were grown until they reached a particle size of around 13-14 μm and subsequently filtrated, washed with deionized water, dried and sieved using a mesh size of 30 μm to obtain inventive pCAM.3.

TABLE 2
morphology of inventive precursor and comparative precursors

| | | | form | span/form | Particle |
|---|---|---|---|---|---|
| pCAM | d50 [μm] | span | factor | factor | ratio* |
| C-pCAM.1 | 13.9 | 0.64 | 0.77 | 0.83 | 3.2 |
| C-pCAM.2 | 13.3 | 0.47 | 0.92 | 0.51 | 2.9 |
| pCAM.3 | 14.0 | 0.39 | 0.95 | 0.41 | 3.4 |

*particle ratio: d50 (pCAM)/d50(step b)

TABLE 3
solubility of Ni under the conditions applied
in the corresponding synthesis steps

| step | Solubility of Ni²⁺ [ppm] |
|---|---|
| (b.1) | 0.1 |
| (c.1) | 610 |
| (c.2) | 320 |
| (c.3) | 320 |

The solubility of Ni²⁺ the liquid phase was determined by ICP-OES after filtration.

1-14. (canceled)

15. A process for making a particulate (oxy)hydroxide of TM with an average particle diameter D50 ranging from 5 μm to 16 μm, as determined by light scattering or LASER diffraction or electroacoustic spectroscopy, wherein TM comprises nickel and wherein the process comprises the steps of:
(a) providing an aqueous solution (α) containing water-soluble salts of Ni and of at least one transition metal selected from Co and Mn, and, optionally, at least one further metal selected from Ti, Zr, Mo, W, Al, Mg, Nb, and Ta, and an aqueous solution (β) containing an alkali metal hydroxide and, optionally, an aqueous solution (γ) comprising ammonia,
(b) combining a solution (α) and a solution (β) and, if applicable, a solution (γ) at a pH ranging from 12.0 to 13.0 in a stirred tank reactor, wherein creating solid particles of a hydroxide containing nickel with the solid particles slurried, and
(c) transferring at least a fraction of the slurry obtained in step (b) into another stirred tank reactor and combining it with a solution (α) and a solution (β) and, if applicable, a solution (γ) at a pH ranging from 11.0 to 12.7 and at conditions wherein the solubility of nickel is higher than in step (b),
wherein a stirring speed is reduced in step (c).

16. The process according to claim 15, wherein the particulate mixed transition metal precursor is selected from hydroxides, carbonates, oxyhydroxides and oxides of TM, wherein TM is a combination of metals according to general formula (I)
(NiₐCo_{b}Mn_{c})_{1-d}M_{d} (I)
with
a ranging from 0.6 to 0.95,
b ranging from 0.025 to 0.2,
c ranging from zero to 0.2, and
d ranging from zero to 0.1,
M is selected from Mg, Al, Ti, Zr, Mo, W, Al, Mg, Nb, and Ta,
a+b+c=1.

17. The process according to claim 15, wherein step (b) has a duration ranging from rt·0.03 to rt·0.10 and wherein rt is an average residence time of the reactor in which steps (b) and (c) are carried out.

18. The process according to claim 15, wherein the stirring speed in the beginning of step (c) is lower than at the end of step (b).

19. The process according to claim 15, wherein the stirring speed in step (c) is reduced continuously.

20. The process according to claim 15, wherein the stirring speed in step (c) is reduced step-wisely.

21. The process according to claim 15, wherein the aqueous solution (γ) comprising ammonia is at a higher concentration in step (c) than in step (b).

22. The process according to claim 15, wherein the pH value in step (c) is lower by at least 0.2 compared to step (b).

22. The process according to claim 15, wherein solution (α) used in step (c) has a different composition compared to the solution (α) used in step (b).

23. The process according to claim 19, wherein the nickel content of solution (α) used in step (c) is lower compared to the nickel content of solutions (α) used in step (b).

24. The process according to claim 15, wherein the addition rates of solutions (α) and (β) and—if applicable—of solution (γ) drops in step (c).

25. The process according to claim 15, wherein in step (c), the stirring speed drops by a factor of 0.25 to 0.75.

26. A particulate mixed metal (oxy)hydroxide with an average particle diameter D50 ranging from 5 μm to 16 μm, as determined by light scattering or LASER diffraction or electroacoustic spectroscopy, and comprising Ni and of at least one transition metal selected from Co and Mn, and, optionally, at least one further metal selected from Ti, Zr, Mo, W, Al, Mg, Nb, and Ta,
wherein primary particles of the particulate mixed metal (oxy)hydroxide in the shell mainly have a radial orientation and the primary particles in the core mainly randomly oriented and
wherein secondary particles of the particulate mixed metal (oxy)hydroxide have a product of span and form factor ranging from 0.3 to 0.6 and a ratio of secondary particle diameter to core diameter below 7.5.

27. A particulate mixed metal (oxy)hydroxide with an average particle diameter D50 ranging from 5 μm to 16 μm, as determined by light scattering or LASER diffraction or electroacoustic spectroscopy, and comprising Ni and of at least one transition metal selected from Co and Mn, and, optionally, at least one further metal selected from Ti, Zr, Mo, W, Al, Mg, Nb, and Ta,
wherein primary particles of the particulate mixed metal (oxy)hydroxide in the shell mainly have a radial orientation and the primary particles in the core mainly randomly oriented and
wherein secondary particles have a product of span and form factor ranging from 0.8 to 1.4 and a ratio of secondary particle diameter to core diameter ranging from 1.2 to 1.6.
